(19) United States
(12) Patent Application Publication
(10) Pub. No.: US 2014/0260650 A1
(43) Pub. Date: Sep. 18, 2014

(54) SILICON PLATE IN PLASTIC PACKAGE

(71) Applicant: Silicon Microstructures, Inc., Milpitas, CA (US)

(72) Inventors: Holger Doering, Sunnyvale, CA (US); Richard J. August, Concord, CA (US); Severino Legaspi, Santa Clara, CA (US)

(73) Assignee: Silicon Microstructures, Inc., Milpitas, CA (US)

(21) Appl. No.: 14/022,233

(22) Filed: Sep. 10, 2013

Related U.S. Application Data
(60) Provisional application No. 61/800,018, filed on Mar. 15, 2013.

(51) Int. Cl. G01L 19/14

(52) U.S. Cl. CPC G01L 19/147
USPC 73/756

(57) ABSTRACT

Circuits, methods, and apparatus that provide pressure sensor devices where pressure sensors may be reliably attached to surfaces in device packages, and where the coefficients of expansion of the pressure sensor and the surface are at least approximately equal. Examples may provide pressure sensor devices where pressure sensors may be reliably attached to surfaces in device packages by providing interposers formed to prevent adhesives used to attach the pressure sensors to surfaces from blocking or encroaching into pressure sensor openings or cavities. These same features may be used to accurately locate a pressure sensor relative to the interposer. Embodiments of the present invention may provide pressure sensor devices where the coefficients of expansion of the pressure sensor and the surface are at least approximately equal by proving interposers that are formed of the same or similar material as the pressure sensors, such as silicon.

### CROSS-REFERENCE TO RELATED APPLICATIONS

This application is a non-provisional of U.S. provisional patent application No. 61/800,018, filed on Mar. 15, 2013, which is incorporated by reference.

### BACKGROUND

Pressure sensing devices have become ubiquitous the past few years as they have found their way into several types of products. Utilized in automotive, industrial, consumer, and medical products, the demand for pressure sensing devices has skyrocketed and shows no signs of abating.

Pressure sensing devices may include pressure sensors as well other components. Pressure sensors may typically include a diaphragm or membrane. When a pressure sensor in a pressure sensing device experiences a pressure, the membrane responds by changing shape. This change in shape causes one or more characteristics of electronic components on the membrane to change. These changing characteristics can be measured, and from this the pressure can be determined.

Often, the electronic components are resistors that are configured as a Wheatstone bridge located on the membrane. As the membrane distorts due to a pressure, the resistance of the resistors change. This change results in an output of the Wheatstone bridge. This change can be measured through wires or leads attached to the resistors.

These pressure sensors and other components (if any) may be packaged in an integrated circuit package. Since the pressures to be measured are external to the package, the package may include an opening. The opening in the package may be part of an opening in the pressure sending device that is partially closed by a membrane of the pressure sensor. In this way, fluids under pressure may pass through the opening in the package where they may reach the membrane of the pressure sensor. The pressure sensor may then measure the fluid pressure.

Various problems may arise in such a configuration. First, the pressure sensors used may be very small. This may make any attachment of a pressure sensor to a surface in the pressure sensing device problematic. Also, the coefficient of expansion of the pressure sensor and attachment surface may be different enough to cause pressure sensing errors.

Thus, what are needed are circuits, methods, and apparatus that provide pressure sensor devices where pressure sensors may be reliably attached to surfaces in device packages, and where the coefficients of expansion of the pressure sensor and the surface are at least approximately equal.

### SUMMARY

Accordingly, embodiments of the present invention may provide circuits, methods, and apparatus that provide pressure sensor devices where pressure sensors may be reliably attached to surfaces in device packages, and where the coefficients of expansion of the pressure sensor and the surface are at least approximately equal.

Embodiments of the present invention may provide pressure sensor devices where pressure sensors may be reliably attached to surfaces in device packages by providing interposers formed to prevent adhesives used to attach the pressure sensors to surfaces from blocking or encroaching into pressure sensor openings or cavities. These same features may be used to accurately locate a pressure sensor relative to the interposer. This is particularly important with very or extremely small geometry pressure sensors, such as those having sides with lengths less than 0.5 mm. Embodiments of the present invention may provide pressure sensor devices where the coefficients of expansion of the pressure sensor and the surface are at least approximately equal by proving interposers that are formed of the same or similar material as the pressure sensors, such as silicon.

An illustrative embodiment of the present invention may provide a pressure sensing device that includes an interposer that may be located between a pressure sensor and a surface of a package for the pressure sensing device. In a specific embodiment of the present invention, the interposer may include an opening formed by a hole extending from a first primary face of the interposer to a second primary face of the interposer. The interposer may further include a notch on the topside of the interposer, the notch surrounding the interposer opening. A pressure sensor having a backside cavity forming an opening on a bottom side of the pressure sensor may be mounted on the interposer. Specifically, the pressure sensor may be at least approximately aligned with the interposer such that the notch on the topside of the interposer is inserted in the opening of the backside cavity of the pressure sensor. An adhesive layer between the pressure sensor and the interposer may secure the pressure sensor relative to the interposer. The interposer may be mounted in the package such that the opening of the interposer may be at least approximately aligned with an opening in the package. The notch may help prevent the adhesive from blocking or encroaching into pressure sensor openings or cavities.

In this and other embodiments of the present invention, the pressure sensor and interposer may be made of the same material, such as silicon, such that the pressure sensor and interposer have the same coefficient of expansion. This, in turn, may reduce stresses over temperature that may otherwise be caused by mismatches in thermal expansion.

Another illustrative embodiment of the present invention may provide a pressure sensing device that includes an interposer that may be located between a pressure sensor and a surface of a package for the pressure sensing device. In a specific embodiment of the present invention, the interposer may include an opening formed by a hole extending through the interposer from one primary face of the interposer to the other primary face of the interposer. The interposer may further include a trench on the topside of the interposer, the trench spaced away from and surrounding the interposer opening. The pressure sensor having a backside cavity forming a frame on a bottom side of the pressure sensor may be mounted on the interposer. Specifically, the pressure sensor may be at least approximately aligned with the interposer such that the frame on the bottom side of the pressure sensor is located in the trench on the topside of the interposer. An adhesive layer between the pressure sensor and the interposer may secure the pressure sensor relative to the interposer. The interposer may be mounted in the package such that the opening of the interposer is at least approximately aligned with an opening in the package.

Another illustrative embodiment of the present invention may provide a pressure sensor component formed by attaching a pressure sensor to an interposer. The interposer may be formed having an opening and a notch, as above. A pressure sensor may be mounted on the interposer, as above. In another illustrative embodiment of the present invention, the interposer may include a trench, as above. Again, a pressure sensor may be mounted on the interposer, as above.

Another illustrative embodiment of the present invention may provide an interposer. The interposer may be formed by etching a hole extending through the interposer from one primary face of the interposer to the other primary face of the interposer. A top side of the interposer may be etched excluding an area around the hole, such that a notch around the hole is formed. In another illustrative embodiment of the present invention, the interposer may be formed by again etching a hole extending through the interposer from one primary face of the interposer to the other primary face of the interposer. An area around and separated from the hole may be etched such that a trench is formed.

Another illustrative embodiment of the present invention may provide a method of manufacturing a pressure sensing device. This method may include forming an interposer by etching a hole extending through the interposer from one primary face of the interposer to the other primary face of the interposer. A top side of the interposer may be etched excluding an area around the hole, such that a notch around the hole is formed. Die-attach or other adhesive may be used to mount a bottom of the interposer to a package, such that the hole in the interposer is at least approximately aligned with a hole in the package. Die-attach or other adhesive may be applied around the notch of the interposer, and a pressure sensor may be located on the interposer such that the notch fits in an opening formed by a backside cavity in the pressure sensor.

Another illustrative embodiment of the present invention may provide another method of manufacturing a pressure sensing device. This method may include forming an interposer by etching a hole extending through the interposer from one primary face of the interposer to the other primary face of the interposer. An area on the topside of the interposer around and separated from the hole may be etched such that a trench is formed. Die-attach or other adhesive may be used to mount a bottom of the interposer to a package, such that the hole in the interposer is at least approximately aligned with a hole in the package. Die-attach or other adhesive may be applied in the trench of the interposer, and a pressure sensor may be located on the interposer such that a frame of the pressure sensor fits in the trench of the interposer.

Various embodiments of the present invention may incorporate one or more of these and the other features described herein. A better understanding of the nature and advantages of the present invention may be gained by reference to the following detailed description and the accompanying drawings.

### BRIEF DESCRIPTION OF THE DRAWINGS

FIG. 1 illustrates a pressure sensing devices according to an embodiment of the present invention;

FIG. 2 illustrates a pressure sensor component according to an embodiment of the present invention;

FIG. 3 illustrates a top side perspective view of an interposer according to an embodiment of the present invention;

FIG. 4 illustrates a method of manufacturing a pressure sensor device according to an embodiment of the present invention;

FIG. 5 illustrates a pressure sensor component according to an embodiment of the present invention;

FIG. 6 illustrates a perspective view of an interposer according to an embodiment of the present invention; and

FIG. 7 illustrates a method of manufacturing a pressure sensor device according to an embodiment of the present invention.

### DESCRIPTION OF ILLUSTRATIVE EMBODIMENTS

FIG. 1 illustrates a pressure sensor device according to an embodiment of the present invention. This figure, as with the other included figures, is shown for illustrative purposes and does not limit either the possible embodiments of the present invention or the claims.

Pressure sensor device 100 may be used to measure external pressures relative to a pressure in reference chamber 155. Specifically, a fluid to be measured may enter pressure sensing device 100 at opening 160, where it may reach a bottom side diaphragm or membrane 122 of the pressure sensor 120. This pressure may be different than the pressure in reference chamber 155. This pressure difference may, in turn, cause a deflection of diaphragm 122. The deflection may cause a change in values one or more components on diaphragm 122, which may be measured through wire bonds, such as wire bonds 170. From the change in values in the one or more components, the pressure of the external fluid may be determined.

More specifically, pressure sensor 100 may include package 150. Package 150 may include opening 152. Interposer 110 may be fixed to a die paddle or other surface in package 150. The attachment may be made using adhesives 132 or other appropriate means. Interposer 110 may include opening 112. Opening 112 may be surrounded by notch 140. Pressure sensor 120 may be located on interposer 110 and may be secured to interposer 110 using adhesive 130. Cavity 124 in a back side of pressure sensor 120 may form an opening in a bottom side of pressure sensor 120. Notch 140 on interposer 110 may fit in this opening. In this way, opening 152 in package 150, opening 112 in interposer 110, and back side cavity 124 in pressure sensor 120, may form a pathway 160 for external fluids. Pressure sensor device 100 may further include one or more other component 180. The one or more other components 180 and pressure sensor 120 may be interconnected to each other and to leads in package 150 using wire bonds 170.

Again, embodiments of the present invention may provide interposers that prevent adhesives used to secure pressure sensors from blocking or encroaching in into these pressure sensor openings and cavities. A close-up view of one such embodiment of the present invention is shown in the following figure.

FIG. 2 illustrates a pressure sensor component according to an embodiment of the present invention. Again, pressure sensor 120 may include diaphragm 122 and back side cavity 124. Interposer 110 may include opening 112. Interposer 110 may include notch 140 around opening 112. Notch 140 may fit in an opening formed by back side cavity 124. Adhesive 130 may be used to secure pressure sensor 120 to interposer 110. Notch 140 may be used to prevent adhesive 130 from blocking the opening in interposer 110 and from blocking or encroaching into fluid pathway 160. Notch 140 may also provide a mechanism whereby pressure sensor 120 may be accurately aligned to interposer 110.

FIG. 3 illustrates a top side perspective view of an interposer 110 according to an embodiment of the present invention. Again, interposer 110 may include opening 112 surrounded by notch 140. In other embodiments of the present invention, notch 140 may be removed from opening 112 by some distance.

FIG. 4 illustrates a method of manufacturing a pressure sensor device according to an embodiment of the present invention. Initially, an interposer is formed. Specifically, in act 410, an interposer is formed by etching a hole through from one primary face of the interposer to another. (In practical terms, a wafer of interposers, or a wafer of interposers and pressure sensors, may be manufactured.) The top side of the interposer may be etched excluding an area around the hole or opening to form a notch in act 420. Die attach adhesive or other adhesive may be used to mount a bottom of the interposer to a package such that a hole in the interposer is at least approximately aligned with a hole in the package in act 430. In act 440, a die attach or other adhesive may be applied around the notch on the top of the interposer. In act 450, a pressure sensor may be mounted on the interposer by aligning the notch on the interposer to an opening formed by a back side cavity of the pressure sensor.

In various embodiment of the present invention, interposers and pressure sensors may be formed of the same or different materials as each other. For example, interposer 110 and pressure sensor 120 may be formed of the same material, such as silicon, so that their coefficients of expansion at least approximately match. In this way, as temperature fluctuates, resulting stresses on pressure sensor 120, which may otherwise occur, are reduced.

While an interposer having a notch or lip is used in this example, in other embodiments the present invention, other structures may be used to protect the pressure sensor device openings and cavities from encroachment by adhesives. An example is shown in the following figure.

FIG. 5 illustrates a pressure sensor component according to an embodiment of the present invention. This figure includes pressure sensor 120 and interposer 510. Pressure sensor 120 may include diaphragm 122. Interposer 510 may include trench 550 surrounding opening 512. Trench 550 may be formed around and removed from opening 512, such that notch or lip 540 is formed. Adhesive 130 may be placed in trench 550 to secure pressure sensor 120 to interposer 510. The resulting structure may prevent adhesive 130 from encroaching in pressure sensor component openings and cavities, such as path 160, opening 512 in interposer 510, and cavity 124 in pressure sensor 120. Trench 550 may also provide a mechanism whereby pressure sensor 120 may be accurately aligned to interposer 510.

FIG. 6 illustrates a perspective view of an interposer according to an embodiment of the present invention. Interposer 510 may include opening 512. Opening 512 may be surrounded by trench 550. Trench 550 may be removed from opening 512 such that notch or lip 540 is formed.

FIG. 7 illustrates a method of manufacturing a pressure sensor device according to an embodiment of the present invention. In act 710, an interposer is formed by etching a hole extending from one primary face of the interposer to the other. In act 720, an area on the top of the interposer surrounding the hole is etched to form a trench. Die attach or other adhesive may be used to mount the interposer in the package such that a hole of the interposer is aligned to a hole on the package. Die attach or other adhesive may be applied to the trench on a top of the interposer. A pressure sensor may be mounted on the interposer by aligning a frame on a bottom of the pressure sensor to the trench.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. An electronic device comprising:
a package having an opening;
an interposer mounted in the package, the interpose comprising:
an opening formed by a hole extending from a first primary face of the interposer to a second primary face of the interposer; and
a notch on the topside of the interposer, the notch surrounding the interposer opening,
wherein a bottom side of the interposer is mounted in the package such that the opening of the interposer is at least approximately aligned with the opening in the package; and
a pressure sensor mounted on the interposer, the pressure sensor having a backside cavity forming an opening on a bottom side of the pressure sensor,
wherein the pressure sensor is at least approximately aligned with the interposer such that the notch on the topside of the interposer is inserted in the opening of the backside cavity of the pressure sensor.

2. The electronic device of claim 1 wherein the package is formed of plastic.

3. The electronic device of claim 2 wherein the opening in the package is formed in a bottom side of the package.

4. The electronic device of claim 1 wherein the interposer is formed of silicon.

5. The electronic device of claim 4 wherein the interposer is mounted in the package using die-attach adhesive.

6. The electronic device of claim 5 wherein the pressure sensor is mounted on the interposer using die-attach adhesive.

7. The electronic device of claim 1 wherein the pressure sensor and the interposer are formed primarily of the same material.

8. The electronic device of claim 1 wherein the pressure sensor and the interposer have at least approximately matching coefficients of thermal expansion.

9. An electronic device comprising:
a package having an opening;
an interposer mounted in the package, the interpose comprising:
an opening formed by a hole extending from a first primary face of the interposer to a second primary face of the interposer; and
a trench on the topside of the interposer, the trench spaced away from and surrounding the interposer opening,
wherein a bottom side of the interposer is mounted in the package such that the opening of the interposer is at least approximately aligned with the opening in the package; and
a pressure sensor mounted on the interposer, the pressure sensor having a backside cavity forming a frame on a bottom side of the pressure sensor,
wherein the pressure sensor is at least approximately aligned with the interposer such that the frame on the bottom side of the pressure sensor is located in the trench on the topside of the interposer.

10. The electronic device of claim 9 wherein the package is formed of plastic.

11. The electronic device of claim 10 wherein the opening in the package is formed in a bottom side of the package.

12. The electronic device of claim 9 wherein the interposer is formed of silicon.

13. The electronic device of claim 12 wherein the interposer is mounted in the package using die-attach adhesive.

14. The electronic device of claim 13 wherein the pressure sensor is mounted on the interposer using die-attach adhesive.

15. The electronic device of claim 9 wherein the pressure sensor and the interposer are formed primarily of the same material.

16. The electronic device of claim 9 wherein the pressure sensor and the interposer have at least approximately matching coefficients of thermal expansion.

17. An electronic component comprising:
an interposer comprising:
an opening formed by a hole extending from a first primary face of the interposer to a second primary face of the interposer; and
a notch on the topside of the interposer, the notch surrounding the interposer opening; and
a pressure sensor mounted on the interposer, the pressure sensor having a backside cavity forming an opening on a bottom side of the pressure sensor,
wherein the pressure sensor is at least approximately aligned with the interposer such that the notch on the topside of the interposer is inserted in the opening of the backside cavity of the pressure sensor.

18. The electronic component of claim 17 wherein the pressure sensor and the interposer have at least approximately matching coefficients of thermal expansion.

19. An electronic component comprising:
an interposer mounted in the package, the interpose comprising:
an opening formed by a hole extending from a first primary face of the interposer to a second primary face of the interposer; and
a trench on the topside of the interposer, the trench spaced away from and surrounding the interposer opening; and
a pressure sensor mounted on the interposer, the pressure sensor having a backside cavity forming a frame on a bottom side of the pressure sensor,
wherein the pressure sensor is at least approximately aligned with the interposer such that the frame on the bottom side of the pressure sensor is located in the trench on the topside of the interposer.

20. The electronic component of claim 19 wherein the pressure sensor and the interposer have at least approximately matching coefficients of thermal expansion.
